(19) United States
(12) Patent Application Publication
(10) Pub. No.: US 2015/0161740 A1
(43) Pub. Date: Jun. 11, 2015

(54) SYSTEMS AND METHODS FOR MANAGING LIFE INSURANCE POLICIES

(71) Applicants: Robert Daniel Stuchiner, New York, NY (US); David Bruce Simon, Chicago, IL (US); Nicomedes Sy Herrera, Piedmont, CA (US)

(72) Inventors: Robert Daniel Stuchiner, New York, NY (US); David Bruce Simon, Chicago, IL (US); Nicomedes Sy Herrera, Piedmont, CA (US)

(21) Appl. No.: 14/551,011

(22) Filed: Nov. 23, 2014

Related U.S. Application Data
(60) Provisional application No. 61/908,694, filed on Nov. 25, 2013.

(51) Int. Cl. G06Q 40/08

(52) U.S. Cl. CPC G06Q 40/08

(57) ABSTRACT

Systems and methods for managing insurance policies donated or to be donated to charity are provided. A representative system of managing insurance policies comprises a processing device and memory that stores a portfolio manager having instructions that are executed by the processing device. The portfolio manager comprises the following logic: allocating donated life insurance policies to at least one receiving entity; pooling the allocated donated life insurance policies for the at least one receiving entity; determining a distribution percentage of the at least one receiving entity and/or the supported charitable organizations of the receiving entity by comparing the allocated donated life insurance policies with the pooled allocated donated life insurance policies; and distributing proceeds to the at least one receiving entity and/or the supported charitable organizations of the receiving entity from the pooled donated life insurance policies based on the determined distribution percentage of the at least one receiving entity and/or the supported charitable organizations of the receiving entity.

### CROSS-REFERENCE TO RELATED APPLICATIONS

This application claims benefit to U.S. provisional application entitled, “SYSTEMS AND METHODS FOR MANAGING LIFE INSURANCE POLICIES,” having Ser. No. 61/908,694, filed on Nov. 25, 2013, which is entirely incorporated herein by reference.

### TECHNICAL FIELD

The present disclosure is generally related to managing life insurance policies and, more particularly, is related to systems and methods for maximizing the efficiency of charitable donations of life insurance policies to one or more charitable organizations.

### BACKGROUND

### I. Particular Problems Faced by Those Working in the Subject Matter Area

Those working in the charitable industry face five major problems relating to the donation of life insurance policies. These problems have a dramatic adverse impact on charity because life insurance represents a $19.2 trillion asset class (American Council of Life Insurers 2012 Fact Book, Table 1.2 at p. 3) where approximately 85% of policies lapse or are surrendered (thereby forfeiting their Value, as defined below)—even though many of them could have been donated to benefit charities. See generally Deloitte Consulting LLP & The University of Connecticut, The Life Settlements Market: An Actuarial Perspective on Consumer Economic Value, 2005, at p. 12. Some of the problems are described below.

First, charities face difficult problems paying the premium of donated policies. Even if a donated policy has significant value, premium are typically paid on the policy until the insured passes away. This presents a drain on current resources of the charity, which makes such gifts impracticable in most cases. Alternatively, if a donor decides to pay premium for the donated policy, many charitable organizations encounter that such a commitment by the donor in practice reduces the annual giving from that donor to fund the charity's current operations. Moreover, such an arrangement often raises significant issues surrounding the certainty of continued payments, particularly as the donor ages and subsequent decision-makers reverse the donor's earlier desire to maintain the policy for the benefit of the charity. Charities also do not want to be put in the uncomfortable position of collecting premium payments every year from their donors. As a result, many large charities no longer allow this form of life insurance donation that has ongoing premium payments to be made.

Second, even if a charity could secure anticipated premium payments, charities do not have the expertise to determine which life insurance policies presented for donation have positive Value and therefore worth maintaining.

Third, charities cannot aggregate sufficient number of policies to make holding policies efficient. Individual policies are binary because the insured is either dead or alive. As a result, a holder of a few policies need to hedge against longevity risk and pay a cost that carries the policy far beyond the relevant life expectancies. On the other hand, a large pool has predictable mortality (based on the large number of lives), and the operator of a pool can pay a much lower carrying cost for each policy because there is no need to hedge longevity. The individuals in a sufficiently large pool who die early subsidize the cost of those individual insured who live longer than expected. The result of holding policies in a large pool is an overall lower cost of carrying the policies and a higher present value of the net death benefits.

Fourth, any distributions to charity under existing methods would only be received as a lump sum payment of death benefits when the insured donor dies. Accordingly, charities are presented with problems in planning current operating budgets because of the lack of predictable and stable distributions from such gifts.

Fifth, charities face problems surrounding the reputation risk of owning an asset that does not inure any benefits until a donor passes away. There is currently no method by which the benefit to supported charities from a donated policy can be disassociated from the death of the donor.

Sixth, donors often receive no current recognition by a charity for the value of their policy donation. With current methods, there is no efficient mechanism to quantify the Value of a donated policy or demonstrate a steady and predictable revenue stream relating to the donation of a single policy. Instead, the contribution of a donor of life insurance is typically recognized by the charity after the donor passes away.

Seventh, under current methods, the donation of a life insurance policy can only be directed to a single charitable organization. There is no mechanism under current methods for a policyholders to donate portions of the Value of a life insurance policy to more than one charitable organization.

### II. Existing Methods for Managing Life Insurance Policies

Virtually all current donations are direct donations by a policyholder to and for the benefit of a single charitable organization. Under traditional methods, the benefited charity typically accepts a paid-up policy and receives death benefit in the remote and uncertain future when the insured donor dies. Moreover, there is no internal mechanism for funding unpaid premium, no option to benefit more than one charitable organization, no system to mitigate the risk of unpredictable cash flow from planned gifts, no ability to unlock the economic value of a donated policy for current programs, and no way to achieve a sufficient pool size to reach actuarial credibility. Although some charities enter into funding agreements with donors who agree to pay premium on donated policies, such arrangements often result in the donor offsetting other annual giving that the charities need to pay for current operations.

Certain schemes for unlocking the intrinsic economic value of policies have recently been attempted, and they have been widely criticized for failing to drive any benefit to charities while possibly abusing the insurable interest of charities in their donors. These schemes generally leverage the insurable interest of a charitable entity in its donors by purchasing new policies on donors in what is commonly known as a “stranger owned and initiated life insurance” or “STOLI” transaction. These schemes have two premises. First, these schemes rely on the dubious assumption that the mortality tables used by an insurance carrier in underwriting the policy undervalue at inception the cost of insurance for that policy. Second, these schemes wager that third-party underwriters are more accurate in predicting the life expectancy of an insured than insurance companies. Together, these assumptions allegedly result in a positive net present value between the death benefit payable at life expectancy and the expected premium to maintain the policy to life expectancy. Such positive net present value, when combined with a standard return on premium that many life insurance policies are designed to provide, is supposedly sufficient not only to provide a return to a third-party investor that supplies the capital to purchase and pay premium on the policy, but also yield a residual value to the charity.

There are pending patent applications in this field that focus on an individual donor initiating a new life insurance policy for the benefit of a specific operating charity without any mechanism for pooling or payment by a third party. See United States Patent Application 20120253853 (filed Jun. 11, 2012) and 20120245965 (filed Jun. 11, 2012). See also Patent Application 20110010204 (filed Jan. 13, 2011) (providing for third party financing of a new policy purchased on a donor of specific charitable institution without pooling). There are also existing patents issued to pair the cash flow from a life insurance policy with an annuity. See, e.g., U.S. Pat. No. 8,4984,943 (filed Oct. 15, 2010). These schemes do not pool donated policies for the benefit of many charitable organizations, and many require the purchase of a new policy based on the insurable interest of a particular tax-exempt organization in the potential donor. The schemes that involve the purchase of new insurance policies utilize a purported underwriting and mortality table arbitrage against insurance carriers.

### III. Disadvantages of Old Methods

Under traditional gifting arrangements, donating life insurance policies to charity presents significant problems that discourage both the donation and the acceptance of such assets. Although many life insurance policies may offer significant value to a charitable organization in the future, gifts of life insurance policies are often rejected by charitable organizations because of the problems surrounding them. This denies charities a source of significant revenue. None of the major problems outlined above are adequately addressed by traditional methods. Under traditional gifting methods, there are no efficient mechanisms for the payment of premium for donated policies. Charitable organizations are left to guess as to which donated policies are worth continuing to pay the premium; accordingly, charities typically do not accept policies that are not fully paid unless the donor agrees to pay premium. Many of the foregoing policies nevertheless lapse when the policy does not perform as expected, or where the donor decides to stop paying premium. Further, many charities do not want to be in a position to constantly monitor and request donors to pay annual premium. Even when a policy is properly funded, individual policy donations to a single charitable organization do not yield any value to the charity possibly for decades, leaving the charity in the position of waiting for their donors to pass away. Finally, donors are not optimally incentivized to donate life insurance policies because the value of individual policy donations are not readily ascertainable or modeled, leaving the value of such donations unrecognized until the donor dies.

A traditional life insurance policy provides for a certain payout or “death benefit” upon the death of the insured or maturity of the policy. If the policy is a permanent policy (as opposed to a term policy that expires after a specific period of time) with cash value, the death benefit amount includes the return of the policy's cash value at the time of maturity. At any point in time prior to maturity, the difference between a policy's total death benefit and any existing cash value is called the “Net Amount at Risk” of the policy (e.g., the amount that the insurance carrier is “at risk” from the death of the insured over the portion of the death benefit that constitutes a return of cash value held by the carrier for the benefit of the insured).

Typically, the “Value” of a policy is the individually determined probabilistic net present value of death benefits minus the net present value of premium. The owner of a life insurance policy needs to have an “insurable interest” in the life of the insured at the time that the insurance policy is purchased. An insurable interest typically refers to an interest based on a reasonable expectation of pecuniary advantage through the continued life, health and bodily safety of the insured, or a substantial interest engendered by love and affection if closely related by blood or by law. Charitable organizations can have an insurable interest in their donors.

Desirable in the art is an improved method of managing charitable donations of life insurance policies that would improve upon the conventional method of managing life insurance policies.

### SUMMARY

The invention described herein (“Invention”) presents a system and method for maximizing the efficiency of charitable donations of life insurance policies to one or more charitable organizations. A representative system of managing insurance policies comprises a processing device and memory that stores a portfolio manager having instructions that are executed by the processing device. The portfolio manager comprises the following logic: allocating charitable donations of life insurance policies to at least one receiving entity; pooling the allocated donated life insurance policies for the at least one receiving entity; determining a distribution percentage of the at least one receiving entity and/or its supported charitable organizations by comparing the allocated donated life insurance policies with the pooled allocated donated life insurance policies; and distributing proceeds to the at least one receiving entity and/or its supported charitable organizations from the pooled donated life insurance policies based on the determined distribution percentage of the at least one receiving entity.

### BRIEF DESCRIPTION OF THE DRAWINGS

The accompanying drawings illustrate preferred embodiments of the invention, as well as other information pertinent to the disclosure, in which:

FIG. 1 is a block diagram that illustrates an embodiment of an environment having portfolio manager that manages life insurance policies;

FIG. 2 is a high-level block diagram that illustrates an embodiment of a method, operation, and functionality of a portfolio manager, such as that shown in FIG. 1;

FIG. 3 is a block diagram that illustrates an embodiment of a method, operation, and functionality of a distribution of proceeds to benefited charitable organization(s), such as that shown in FIG. 1;

FIG. 4 is a high-level block diagram that illustrates an embodiment of a method, operation, and functionality of a portfolio manager, such as that shown in FIG. 1;

FIG. 5 is a detailed block diagram that illustrates an embodiment of a method, operation, and functionality of a portfolio manager, such as that shown in FIG. 1; and

FIG. 6 is a block diagram illustrating an exemplary architecture for a generic computer 600 that is similar to the architecture of the computing device, such as that shown in FIG. 1.

### DETAILED DESCRIPTION

The Invention focuses on the aggregation of currently existing policies donated or to be donated for charitable purposes without recourse to the insurable interest of potential donors to the supported charity. In general, the Invention involves the pooling of life insurance policies and allocating distributions from a pool of policies based on the relative economic Value of the assigned policy compared with the aggregate Value of any or all policies donated to the pool. Distributions are not based on the “statistical probability” of an “occurrence” during each discrete time period, but rather on the proportionate Value of the assigned policy regardless of the expected maturity of that policy in a particular discrete time period.

The Invention provides a superior method to at least one of the following: (i) maximize the value to charity of life insurance policies donated to charity by translating the intrinsic economic value of a life insurance policy into a periodic and relatively stable and predictable stream of revenue; (ii) fund the premium for life insurance policies donated to charity; (iii) allow for a single donated policy to benefit one or more separate charities; (iv) disassociate the benefit to supported charities from the death a particular individual donor; (v) convert an otherwise testamentary gift into a lifetime gift to supported charities; (vi) mitigate the risk of unpredictable cash flow from planned gifts; and (vii) provide for an efficient mechanism to aggregate a sufficiently large pool of donated policies for charitable distributions that is actuarially credible so as to mitigate the need to hedge longevity, lower the overall cost of carrying the policies, and achieve a higher present value of the net death benefits.

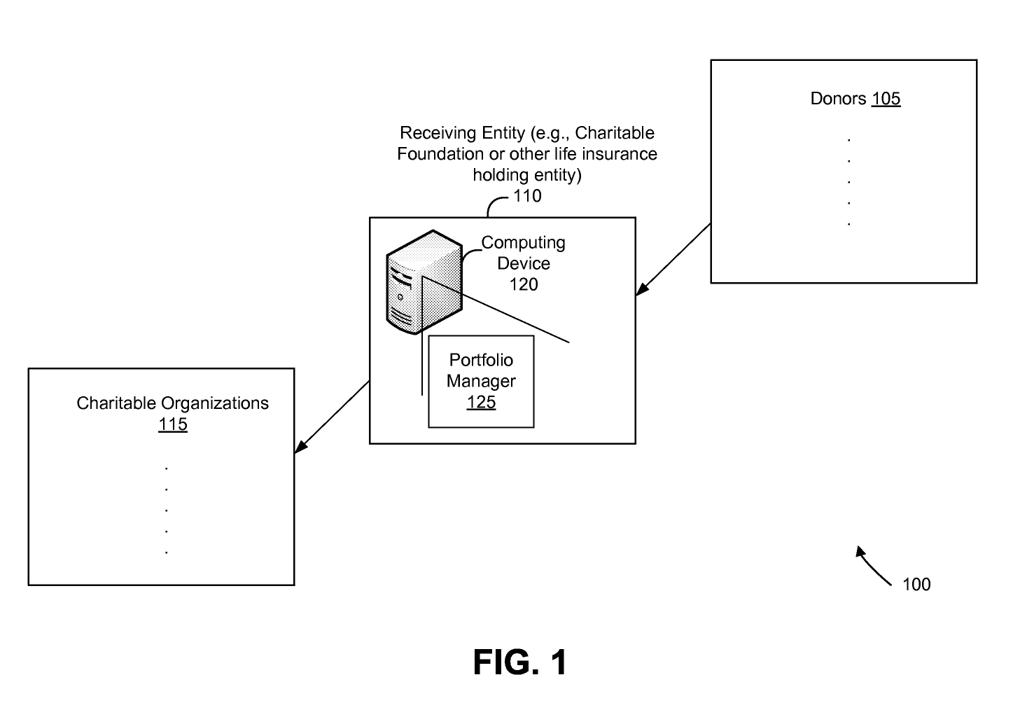

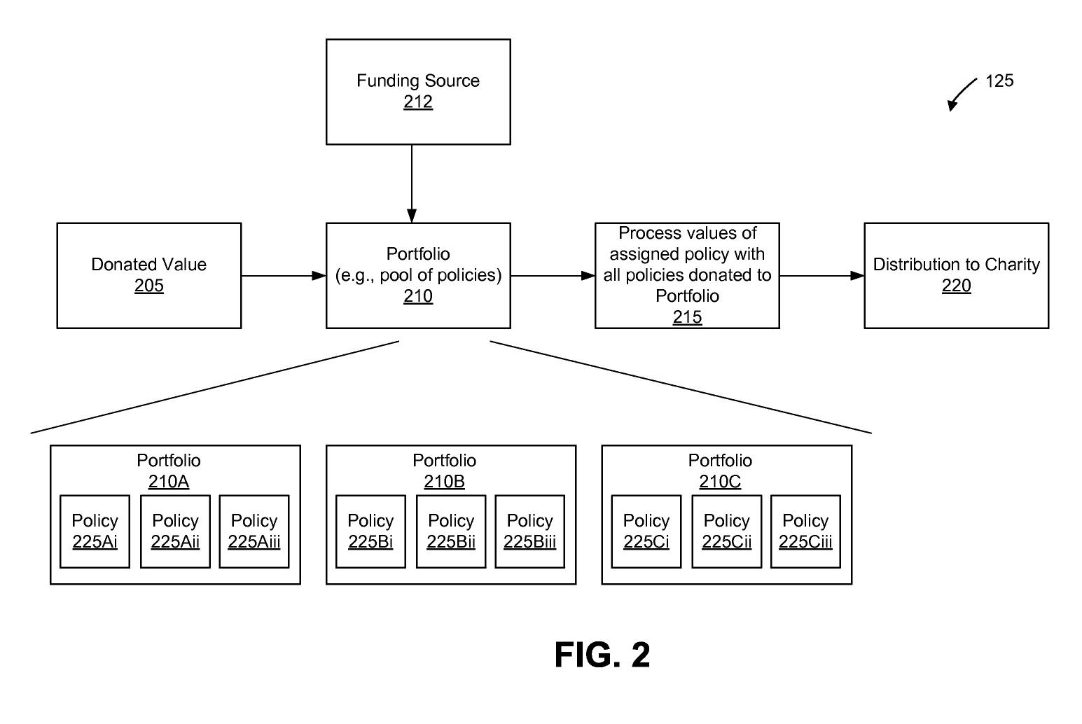

FIG. 1 is a block diagram that illustrates an embodiment of an environment 100 having portfolio manager that manages life insurance policies. Donors 105 donate to a life insurance policy to support one or more charities. A receiving entity (e.g., charitable foundation or other life insurance holding entity) 110 receives the donation and processes/manages the life insurance policy using a portfolio manager 125 stored and executed on a computing device 120. Based on the processing of the life insurance policy, the receiving entity distributes proceeds to benefited charitable organization(s) 115. The method, operation, and functionality of the portfolio manager 125 are further described in connection to FIGS. 2-4.

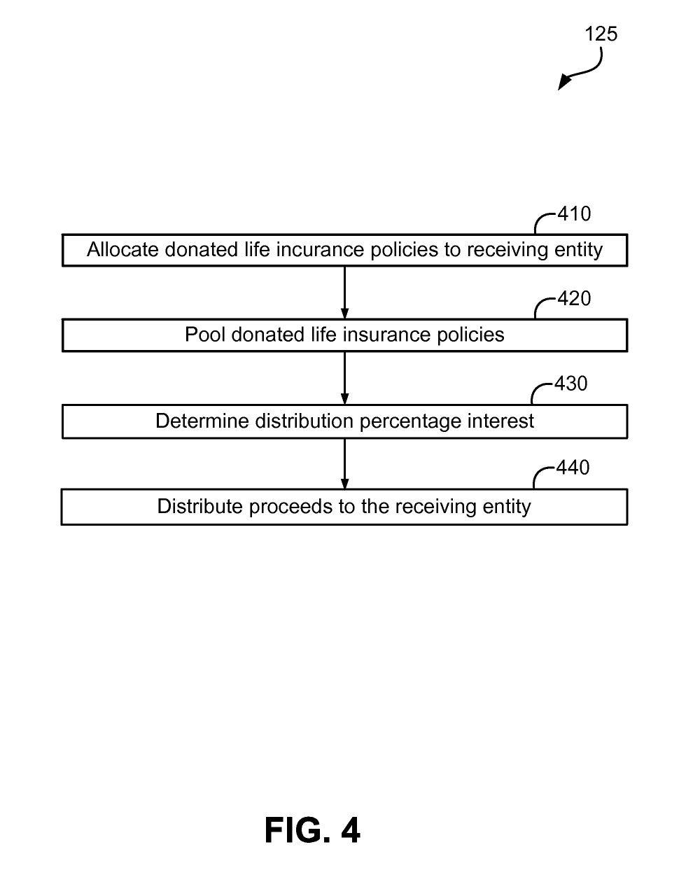

FIG. 2 is a high-level block diagram that illustrates an embodiment of a method, operation, and functionality of a portfolio manager 125, such as that shown in FIG. 1. In block 205, the portfolio manager 125 is inputted with a donated value corresponding to the donation from the donor 105. In block 210, the portfolio manager 125 can create new life insurance portfolios or store the donation with an existing portfolio of life insurance policies. The policies are placed in a portfolio. For example, Policies 225Ai, 225Aii, 225Aiii are in placed in portfolio 210A; policies 225Bi, 225Bii, 225Biii are in placed in portfolio 210B; and policies 225Ci, 225Cii, 225Ciii are in placed in portfolio 210C. The portfolio manager 125 pools the policies into a portfolio 210 and determines whether the policies are funded through a third-party loan, guarantee or equity investment, for example. In blocks 215 and 220, the portfolio manager 125 processes the values of the assigned policy with any or all policies donated to the relevant portfolio and distributes the proceeds to the benefited charitable organization(s) 115 based on the processing. Such process is further described in connection to FIG. 4.

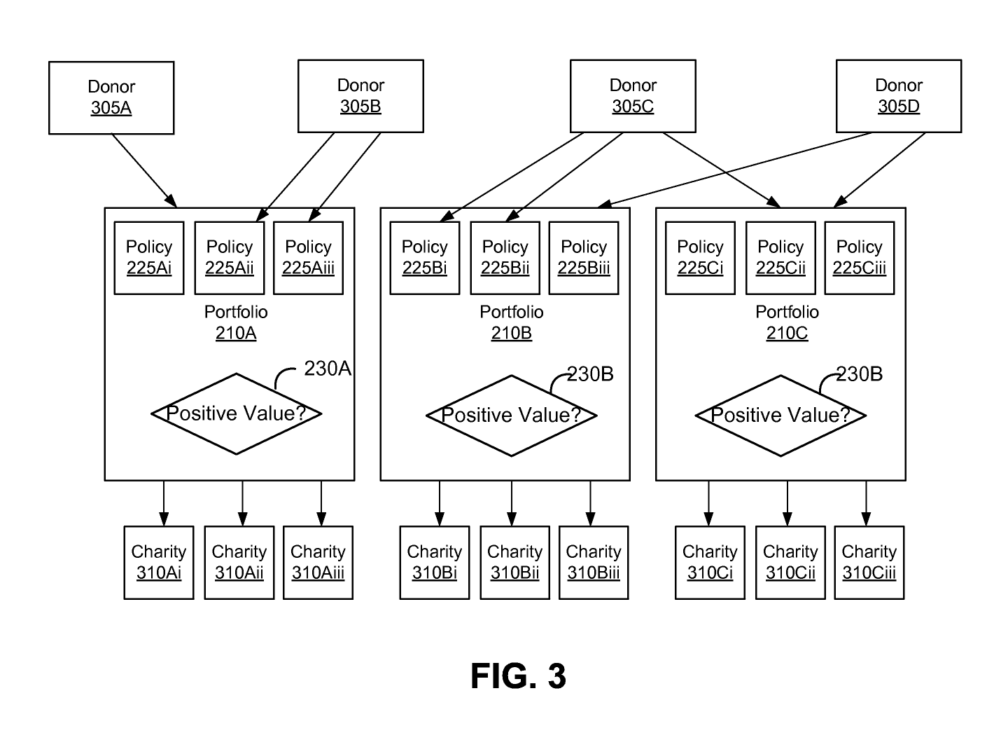

FIG. 3 is a block diagram that illustrates an embodiment of a method, operation, and functionality of a distribution of proceeds to benefited charitable organization(s) 115, such as that shown in FIG. 1. Donors 305A, B, C, D donates to portfolio 210A, B, C, each having one or more policies, 225Ai, 225Aii, 225Aiii, 225Bi, 225Bii, 225Biii, 225Ci, 225Cii, 225Ciii, respectively. In block 230, the portfolio manager 125 determines if the policies have sufficient positive Value to provide distributions to the benefited charities 115. Responsive to the determination that the Value is sufficiently positive, the portfolio manager 125 can facilitate the distribution of proceeds to the benefited charitable organizations 115.

FIG. 4 is a high-level block diagram that illustrates an embodiment of a method, operation, and functionality of a portfolio manager 125, such as that shown in FIG. 1. In blocks 410 and 420, the portfolio manager 125 assesses the Value of life insurance policies offered for suitability, allocates suitable donated life insurance policies to at least one receiving entity, and pools the allocated donated life insurance policies for the at least one receiving entity in one or more portfolios of the receiving entity. In blocks 430 and 440, the portfolio manager 125 determines a distribution percentage of the at least one receiving entity and distributes proceeds to the at least one receiving entity from the pooled donated life insurance policies based on the determined distribution percentage of the at least one receiving entity.

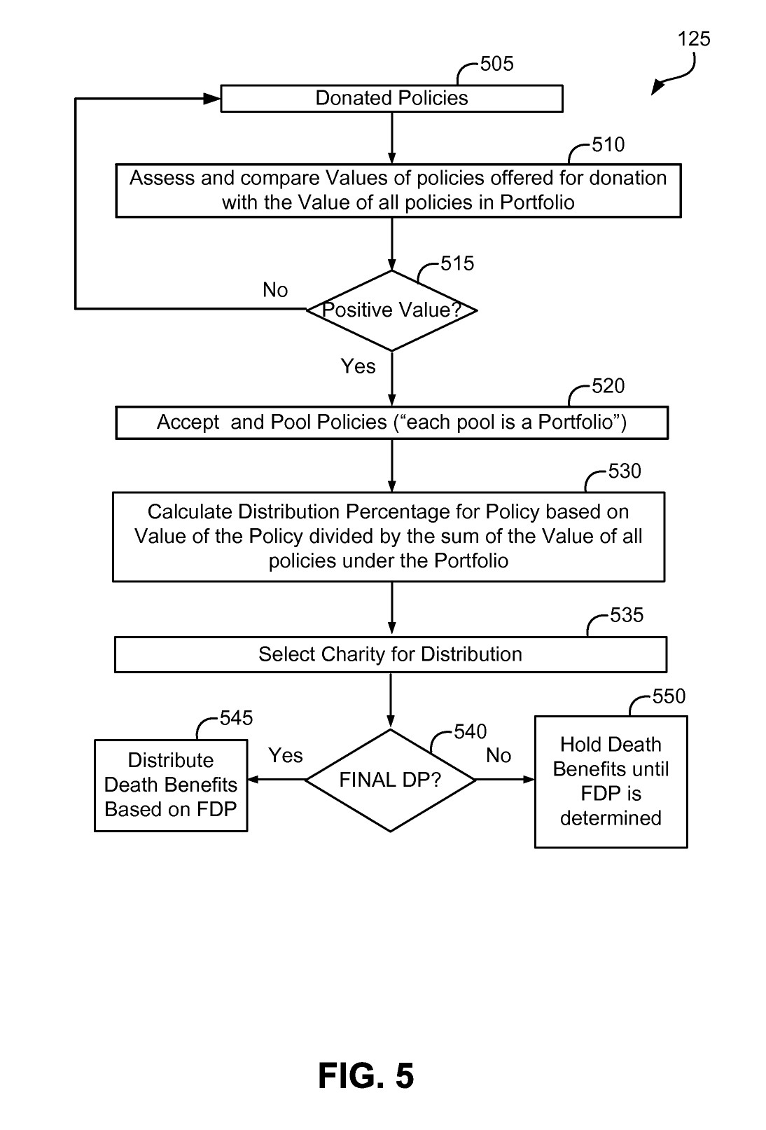

FIG. 5 is a detailed block diagram that illustrates an embodiment of a method, operation, and functionality of a portfolio manager 125, such as that shown in FIG. 1. In block 505, the portfolio manager 125 receives the value of the donation and assigns them to a policy 225 that is in a portfolio 210 (FIG. 2). In block 510, the portfolio manager 125 assesses and compares the Value of the assigned policy with any or all policies in the portfolio.

In block 515, the portfolio manager 125 evaluates the comparison of the Values to determine if the policies 225 have sufficient positive Value to provide adequate distributions to supported charities 115. Alternatively or additionally, the portfolio manager 125 evaluates whether a particular proffered policy has sufficient positive Value. The evaluation of a proffered policy's Value applies cash value testing and medical underwriting criteria including, without limitation, age, sex, smoking status, medical history, policy design (e.g., premium loads and other fees, shadow accounts, and contractual guarantees, among other factors) and length of time the policy has been in forced, to calculate the probabilistic net present value of death benefits minus premium using a commercially reasonable discount rate. The probabilistic net present value of death benefits minus premium is referred to as the Value of the policy. If a life insurance policy has insufficient value, the portfolio manager 125 continues to receive donations from other donors 105 at block 505. Alternatively and additionally, policies may be assigned without medical underwriting as described above if the characteristics of such policy lead to the statistical likelihood that such category of policies is likely to have sufficient positive Value.

If a life insurance policy has sufficient positive Value, the policies in block 520 are accepted for donation and assigned by the donor to an entity formed to pool any or all policies accepted for donation (the “Receiving Entity”). The Receiving Entity may contain one or more discrete pools of donated policies (each, a “Portfolio”), but each policy that is assigned to the Receiving Entity is allocated to a particular and specified Portfolio. Alternatively or additionally, the Receiving Entity is a pass-through entity that provides distributions to supported charitable organizations and is an operating charitable organization. Alternatively or additionally, there are no discrete and specified Portfolios, and any or all policies are generally held by the Receiving Entity without discrete pools. The calculation of the Distribution Percentage in block 530 is adjusted accordingly.

In block 530, at or near the time that a policy is transferred to the Receiving Entity, the policy is assigned a distribution percentage in the total net death benefits received by a Portfolio within the Receiving Entity (the “Distribution Percentage”). The Distribution Percentage allocated to a donated policy is equal to the Value of the policy (the “Distribution Percentage Numerator”) divided by the sum of the Values of any or all policies donated to such Portfolio (the “Distribution Percentage Denominator”). As additional policies are assigned to a particular Portfolio, the Distribution Percentage assigned to each policy in such Portfolio is adjusted to account for the increase in the Distribution Percentage Denominator resulting from new policies added to such Portfolio. Once a Portfolio is filled based on the initial size parameters set for such Portfolio, the Portfolio is closed, and the Distribution Percentage for each policy in the Portfolio becomes fixed (the “Final Distribution Percentage”). Any policy that matures or pays a death benefit before the relevant Portfolio is closed can be assigned a Final Distribution Percentage when the relevant Portfolio is closed as if the policy had not matured or paid a death benefit.

Alternatively or additionally, the Distribution Percentage is recalculated as specified except that the Distribution Percentage Numerator is also recalculated to adjust for any changes in Value of a particular policy (in addition to adjusting the Distribution Percentage Denominator based on the addition of additional policies). Alternatively or additionally, the adjustments of the Distribution Percentage Denominator based on the assignment of additional policies is recalculated to also account for any changes in the Value of any or all of the policies assigned to a Portfolio, or if there are no separate Portfolios, to the Receiving Entity. Alternatively or additionally, both the Distribution Percentage Numerator and the Distribution Percentage Denominator are adjusted according to the above-mentioned adjustments.

Alternatively or additionally, a Portfolio is left open, and no Final Distribution Percentages are assigned to any policy in such Portfolio. In this situation, Distribution Percentages are recalculated periodically (each, a “Calculation Period”), or as adjusted as mentioned above. Also in this situation, any policy that matures or pays a death benefit can be assigned a Value of $0 and removed from any relevant Portfolio during any subsequent Calculation Period after the Calculation Period in which such maturity occurs, or assigned a different arbitrary Value. In this scenario, any or all distributions can be made in accordance with the Distribution Percentages existing during such Calculation Period.

Alternatively or additionally, the Distribution Percentage or Final Distribution Percentage may be issued as formal shares, series shares or other interests in an entity that serves a similar function to the Receiving Entity (as opposed to an internal assignation or association that matches a policy with its corresponding Distribution Percentage from a Portfolio or the Receiving Entity, as appropriate).

In block 535, the donor specifies which charity or charities the donor wishes to support. In the alternative, the donor may decide to leave such decision to the discretion of the managers of the Receiving Entity. The Final Distribution Percentage relating to each donated policy can be allocated on a proportional basis to the supported charities according to the wishes of the donor or by the managers of the Receiving Entity, as appropriate. Instead of specific charities, Final Distribution Percentages may also be assigned to general fund that can be distributed by the managers of the Receiving Entity to charitable organizations in their discretion.

Alternatively or additionally, the supported charity or charities may be enumerated in a fixed list. The Receiving Entity or its designee can inform the donor the implied Value of such donated policy, including projections of the actuarially expected cash flow distributions for the benefit of the supported charity (or charities).

Alternatively or additionally, as policies are accepted for donation to the Receiving Entity, the Receiving Entity pays the premium of donated policies. Any reasonable commercial method to fund the donated policies may be employed, including, without limitation (i) loans; (ii) the issuance of bonds or other debt instruments to fund a premium reserve; (ii) equity and other capital provided by equity or debt investors; or (iii) the use of funds or capital otherwise available to the Receiving Entity, such as retained earnings from prior operations.

In block 540, the portfolio manager 125 determines whether the final distribution percentage is determined and the portfolio is closed. If so, in block 545, when death benefits are received by the Receiving Entity with respect to any life insurance policy assigned to the Receiving Entity, the death benefits are distributed to supported charities in accordance with the Final Distribution Percentages assigned to each such supported charity, or from any general fund to charitable organizations chosen by managers of the Receiving Entity (after deduction to cover the costs and expenses of the program, including, without limitation, financing costs, program expenses and management fees). In block 550, if death benefits are received by the Receiving Entity with respect to any Portfolio that has not yet closed, the death benefits can be held by the Receiving Entity for distribution after Final Distribution Percentages are assigned.

Alternatively or additionally, distributions may be made based on Distribution Percentages if Final Distribution Percentages are unavailable or otherwise cannot be calculated, such as with an open-ended Portfolio. Alternatively or additionally, distributions may be made periodically in a Calculation Period according to Distribution Percentages or Final Distribution Percentages, as applicable, and cease in any subsequent Calculation Periods (regardless of whether the Portfolio is closed or open-ended) after the policy matures, pays a death benefit, or otherwise terminates.

As described herein, an improved method of managing life insurance policies donated or to be donated to charity is presented utilizing the pooling of life insurance policies and allocating the right to distributions from a pool of policies based on a relative value of the assigned policy compared with the aggregate Value of any or all policies donated to the pool. This approach allows for the at least the following advantages:

First, the Invention can enable charities to receive a current and stable distribution stream. Under traditional gifts of life insurance policies, charities do not receive any income until their benefactor dies. In contrast, the Invention unlocks the actuarially expected value of a donated policy and provides charities with a relatively steady stream of distributions.

Second, the Invention can eliminate the burden and risk to charities relating to premium payments. Under traditional gifts of life insurance policies, charities would incur the burden and risk of paying premium on donated policies until maturity, presenting a practical barrier for such gifts even if the intrinsic value of the policy were significant. In contrast, the Invention allows charities to receive relatively steady distributions from a pool of donated policies without incurring the burden or risk of paying their premium. This allows the donation of life insurance to fund current programs, transforming what would otherwise be a testamentary gift into a lifetime gift of current revenue.

Third, the Invention facilitates the ability of donors to be recognized for the Value of their policy donation during their lifetime.

Fourth, the Invention can ameliorate the reputation risk to charities of holding mortality assets. Under traditional gifts of life insurance policies, charities are placed in the untenable position of waiting for their loyal supporters to pass away before receiving any benefit. The Invention substantially lessens this perceived moral hazard because the policies are aggregated with many other policies donated for the benefit of charity. The Invention therefore disassociates the benefit to a particular charity from the death a particular individual donor because distributions are made on a current basis based on a pro rata share in a Portfolio.

Fifth, the Invention allows for a single donated policy to benefit one or more unrelated charities. Under current gifting programs, each donated life insurance policy can benefit only one specified charity.

Sixth, the Invention reduces the carrying cost of holding life insurance policies and reduces the need to hedge longevity risk.

### Points of the Invention Thought to be Advantageous

There are at least eight (8) features of the Invention that are advantageous. First, contrary to the focus of current methods of donating life insurance to charities and to schemes that are the subject of currently pending patent applications (e.g., Patent Application Numbers 20120253853; 20120245965; and 20110010204), the Invention focuses on the donation of preexisting life insurance policies that does not require leveraging the insurable interests of charities in their donors.

Second, the Invention creates an efficient mechanism for third-party investors to earn a profit financing the donation of life insurance to charities while leaving substantial value to supported charities. There is increased value to supported charities because policies targeted for donation under the Invention are not newly purchased (and therefore do not rely on a supposed arbitrage from current mispricing in the mortality tables utilized by the relevant insurance carrier or by underwriting).

Third, the Invention mitigates the risk of unpredictable cash flow from planned gifts. Whereas current methods provide for a single payout to charity upon the future death of a donor, the Invention provides for relatively steady, periodic and current distributions to charity based on pro rata distributions from a large, well-diversified pool.

Fourth, the Invention pools donated life insurance in a way that allows a single donation to benefit multiple charitable organizations. All current methods (including methods subject to pending patent applications) typically benefit only one charitable organization for each policy donation.

Fifth, the current Invention provides for a fractional distribution based on the Value of a policy over the entire life of the donation pool, unconstrained by a specific time period.

Sixth, the current Invention reduces the reputation risk of charities profiting from the death of their donors.

Seventh, the current Invention reduces the need to hedge longevity risk and the carrying cost of holding life insurance policies for charity.

Eighth, the current Invention allows an efficient way for donors to be recognized for the value of their charitable donation of life insurance while they are still alive.

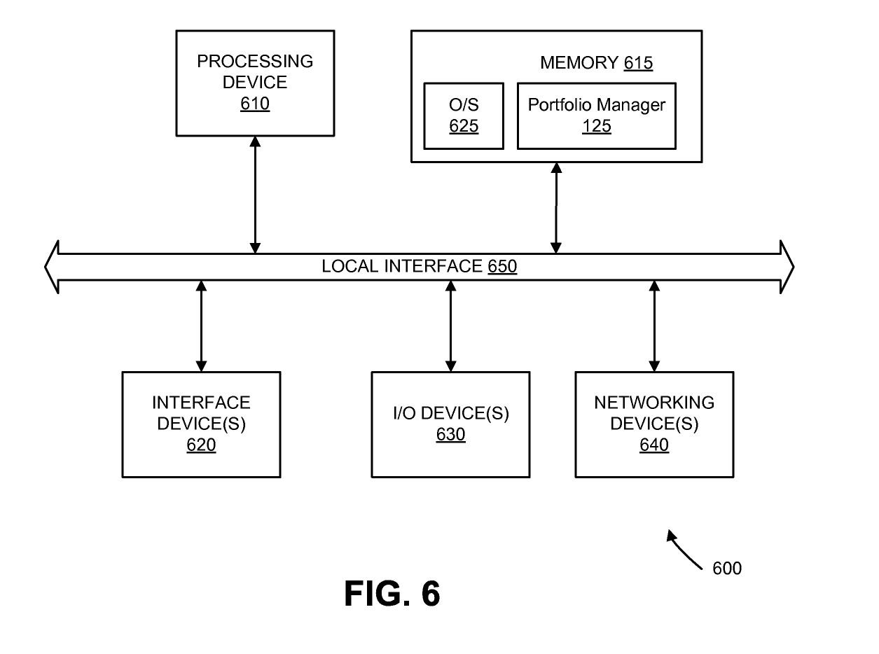

FIG. 6 is a block diagram illustrating an exemplary architecture for a generic computer 600 that is similar to the architecture of the computing device 120, such as that shown in FIG. 1. As indicated in FIG. 6, the computing generic computer 600 comprises a processing device 610, memory 615, one or more user interface devices 620, one or more input and output (I/O) devices 630, and one or more networking devices 640, each of which is connected to a local interface 650. The processing device 610 can include any custom made or commercially available processor, a central processing unit (CPU) or an auxiliary processor among several processors associated with the generic computer 600, a semiconductor based microprocessor (in the form of a microchip), quantum based processor, or a macroprocessor. The memory 615 can include any one or a combination of volatile memory elements (e.g., random access memory (RAM, such as DRAM, SRAM, etc.)) and nonvolatile memory elements (e.g., ROM, hard drive, tape, CDROM, etc.).

The one or more user interface devices 620 comprise those components with which the user (e.g., administrator) can interact with the generic computer 600. Where the generic computer 600 comprises a server computer or similar device, these components can comprise those typically used in conjunction with a PC such as a keyboard and mouse.

The one or more I/O devices 630 comprise components used to facilitate connection of the generic computer 600 to other devices and therefore, for instance, comprise one or more serial, parallel, small system interface (SCSI), universal serial bus (USB), or IEEE 1394 (e.g., Firewire™) connection elements. The networking devices 640 comprise the various components used to transmit and/or receive data over networks (not shown), where provided. By way of example, the networking devices 640 include a device that can communicate both inputs and outputs, for instance, a modulator/demodulator (e.g., modem), a radio frequency (RF) or infrared (IR) transceiver, a telephonic interface, a bridge, a router, as well as a network card, etc.

The memory 615 normally comprises various programs (in software and/or firmware) including an operating system (O/S) 625. The O/S 625 controls the execution of programs, and provides scheduling, input-output control, file and data management, memory management, and communication control and related services.

The systems and methods disclosed herein can be implemented in software, hardware, or a combination thereof. In some embodiments, the system and/or method is implemented in software that is stored in a memory and that is executed by a suitable microprocessor (μP) situated in a computing device. However, the systems and methods can be embodied in any computer-readable medium for use by or in connection with an instruction execution system, apparatus, or device. Such instruction execution systems include any computer-based system, processor-containing system, or other system that can fetch and execute the instructions from the instruction execution system. In the context of this disclosure, a “computer-readable medium” can be any means that can contain, store, communicate, propagate, or transport the program for use by, or in connection with, the instruction execution system. The computer readable medium can be, for example, but not limited to, a system or propagation medium that is based on electronic, magnetic, optical, electromagnetic, infrared, or semiconductor technology.

Specific examples of a computer-readable medium using electronic technology would include (but are not limited to) the following: an electrical connection (electronic) having one or more wires; a random access memory (RAM); a read-only memory (ROM); an erasable programmable read-only memory (EPROM or Flash memory). A specific example using magnetic technology includes (but is not limited to) a portable computer diskette. Specific examples using optical technology include (but are not limited to) optical fiber and compact disc read-only memory (CD-ROM).

Note that the computer-readable medium could even be paper or another suitable medium on which the program is printed. Using such a medium, the program can be electronically captured (using, for instance, optical scanning of the paper or other medium), compiled, interpreted or otherwise processed in a suitable manner, and then stored in a computer memory. In addition, the scope of the certain embodiments of the present disclosure includes embodying the functionality of the preferred embodiments of the present disclosure in logic embodied in hardware or software-configured mediums.

It should be noted that any process descriptions or blocks in flowcharts should be understood as representing modules, segments, or portions of code which include one or more executable instructions for implementing specific logical functions or steps in the process. As would be understood by those of ordinary skill in the art of the software development, alternate embodiments are also included within the scope of the disclosure. In these alternate embodiments, functions may be executed out of order from that shown or discussed, including substantially concurrently or in reverse order, depending on the functionality involved.

This description has been presented for purposes of illustration and description. It is not intended to be exhaustive or to limit the disclosure to the precise forms disclosed. Obvious modifications or variations are possible in light of the above teachings. The embodiments discussed, however, were chosen to illustrate the principles of the disclosure, and its practical application. The disclosure is thus intended to enable one of ordinary skill in the art to use the disclosure, in various embodiments and with various modifications, as are suited to the particular use contemplated. All such modifications and variation are within the scope of this disclosure, as determined by the appended claims when interpreted in accordance with the breadth to which they are fairly and legally entitled.

1. A system of managing insurance policies donated or to be donated for the benefit of charity, the system comprising:
a processing device; and
memory that stores a portfolio manager having instructions that are executed by the processing device, the portfolio manager comprises the following logic:
allocating donated life insurance policies to at least one receiving entity;
pooling the allocated donated life insurance policies for the at least one receiving entity;
determining a distribution percentage of the at least one receiving entity and/or the supported charitable organizations of the receiving entity by comparing the allocated donated life insurance policies with the pooled allocated donated life insurance policies; and
distributing proceeds to the at least one receiving entity and/or the supported charitable organizations of the receiving entity from the pooled donated life insurance policies based on the determined distribution percentage of the at least one receiving entity.

2. The system as defined in claim 1, wherein the logic of determining the Distribution Percentage is achieved by dividing the calculated Value of the allocated donated life insurance policies with the total aggregate Value of all the pooled donated life insurance policies.

3. The system as defined in claim 1, wherein the portfolio manager further comprises the following logic:
allocating additional donated life insurance policies to the at least one receiving entity;
pooling the allocated additional donated life insurance policies for the at least one receiving entity; and
adjusting the distribution percentage of the at least one receiving entity and/or the supported charitable organizations of the receiving entity based on the pooled additional donated life insurance policies.

4. The system as defined in claim 3, wherein the portfolio manager further comprises the following logic:
adjusting periodically the distribution percentage of the at least one receiving entity and/or the supported charitable organizations of the receiving entity.

5. The system as defined in claim 1, wherein the portfolio manager further comprises the following logic:
determining that the pooled donated life insurance polices are closed from pooling additional donated life insurance policies; and
distributing a fixed amount of proceeds to the at least one receiving entity from the pooled donated life insurance policies responsive to the pooled donated life insurance polices being closed.

6. The system as defined in claim 5, wherein the portfolio manager further comprises the following logic:
receiving death benefits related to the donated life insurance policies that are allocated to the at least one receiving entity and/or the supported charitable organizations of the receiving entity;
distributing the death benefits to the at least one receiving entity and/or the supported charitable organizations of the receiving entity;

7. The system as defined in claim 1, wherein the portfolio manager further comprises the logic of:
evaluating whether the donated life insurance policies have a sufficient positive value to provide adequate distributions to the at least one receiving entity.

8. The system as defined in claim 7, wherein the positive value is determined by applying medical underwriting criteria that includes, without limitation, age, sex, smoking status, medical history, policy design (e.g., premium loads and other fees, shadow accounts, and contractual guarantees, among other factors) and length of time the policy has been in forced, to calculate the probabilistic net present value of death benefits minus premium using a commercially reasonable discount rate.

9. A method for managing insurance policies comprising:
allocating donated life insurance policies to at least one receiving entity;
pooling the allocated donated life insurance policies for the at least one receiving entity;
determining a distribution percentage of the at least one receiving entity and/or the supported charitable organizations of the receiving entity by comparing the calculated Value of the allocated donated life insurance policies with the aggregate Value of all pooled allocated donated life insurance policies; and
distributing proceeds to the at least one receiving entity and/or the supported charitable organizations of the receiving entity from the pooled donated life insurance policies based on the determined distribution percentage of the at least one receiving entity and/or the supported charitable organizations of the receiving entity.

10. The method as defined in claim 9, wherein the step of determining the distribution percentage is achieved by dividing the calculated Value of the allocated donated life insurance policies with the aggregate Value of all pooled donated life insurance policies.

11. The method as defined in claim 9, further comprises:
allocating additional donated life insurance policies to the at least one receiving entity;
pooling the allocated additional donated life insurance policies for the at least one receiving entity and/or the supported charitable organizations of the receiving entity; and
adjusting the distribution percentage of the at least one receiving entity and/or the supported charitable organizations of the receiving entity based on the pooled additional donated life insurance policies.

12. The method as defined in claim 11, further comprises adjusting periodically the distribution percentage of the at least one receiving entity and/or the supported charitable organizations of the receiving entity.

13. The method as defined in claim 9, further comprises:
determining that the pooled donated life insurance policies are closed from pooling additional donated life insurance policies; and
distributing a fixed amount of proceeds to the at least one receiving entity and/or the supported charitable organizations of the receiving entity from the pooled donated life insurance policies responsive to the pooled donated life insurance polices being closed.

14. The method as defined in claim 13, further comprises:
receiving death benefits related to the donated life insurance policies that are allocated to the at least one receiving entity and/or the supported charitable organizations of the receiving entity;
distributing the death benefits to the at least one receiving entity and/or the supported charitable organizations of the receiving entity;

15. The method as defined in claim 9, further comprises evaluating whether the donated life insurance policies have a sufficient positive value to provide adequate distributions to the at least one receiving entity and/or the supported charitable organizations of the receiving entity.

16. A portfolio manager that manages insurance policies, the portfolio manager being stored in memory and having instructions that are executed by a processing device, the portfolio manager comprising the following logic:
allocating donated life insurance policies to at least one receiving entity;
pooling the allocated donated life insurance policies for the at least one receiving entity;
determining a distribution percentage of the at least one receiving entity and/or the supported charitable organizations of the receiving entity by comparing the calculated Value of the allocated donated life insurance policies with the aggregate Value of all pooled allocated donated life insurance policies; and
distributing proceeds to the at least one receiving entity and/or the supported charitable organizations of the receiving entity from the pooled donated life insurance policies based on the determined distribution percentage of the at least one receiving entity and/or the supported charitable organizations of the receiving entity.

17. The portfolio manager as defined in claim 16, wherein the logic of determining the distribution percentage is achieved by dividing the calculated Value of the allocated donated life insurance policies with the total Value of all pooled donated life insurance policies.

18. The portfolio manager as defined in claim 16, further comprises the following logic:
allocating additional donated life insurance policies to the at least one receiving entity and/or the supported charitable organizations of the receiving entity;
pooling the allocated additional donated life insurance policies for the at least one receiving entity and/or the supported charitable organizations of the receiving entity; and
adjusting the distribution percentage of the at least one receiving entity and/or the supported charitable organizations of the receiving entity based on the pooled additional donated life insurance policies.

19. The portfolio manager as defined in claim 18, further comprises the following logic:
adjusting periodically the distribution percentage of the at least one receiving entity and/or the supported charitable organizations of the receiving entity.

20. The portfolio manager as defined in claim 16, further comprises the following logic:
determining that the pooled donated life insurance polices are closed from pooling additional donated life insurance policies; and
distributing a fixed amount of proceeds to the at least one receiving entity and/or the supported charitable organizations of the receiving entity from the pooled donated life insurance policies responsive to the pooled donated life insurance polices being closed.
